(19) United States
(12) Patent Application Publication
(10) Pub. No.: US 2020/0154941 A1
(43) Pub. Date: May 21, 2020

(54) HIGH TEMPERATURE PITCHER

(71) Applicant: GARY TORREY, BOISE, ID (US)

(72) Inventor: GARY TORREY, BOISE, ID (US)

(21) Appl. No.: 16/687,553

(22) Filed: Nov. 18, 2019

Related U.S. Application Data
(60) Provisional application No. 62/768,736, filed on Nov. 16, 2018.

(51) Int. Cl. A47J 36/02; A47G 19/18; A23L 23/00

(52) U.S. Cl. CPC A47J 36/027; A23V 2002/00; A23L 23/00; A47G 19/18

(57) ABSTRACT

A container made of a high temperature resin to be used with food items, such as butter, that can withstand temperatures over 300° and a method for making hollandaise sauce using a container made of high temperature resin that can withstand temperatures over 300°. The container has a container body, a handle, a spout, and a removable lid. The lid is configured to securely attach to the container body to allow for pouring while the container lid is attached to the container body.

### PRIORITY/CROSS-REFERENCE TO RELATED APPLICATIONS

This application claims the benefit of U.S. Provisional Application No. 62/768,736, filed Nov. 16, 2018, the disclosure of which is incorporated by reference.

### TECHNICAL FIELD

The presently disclosed technology relates generally a container made of a high-temperature resin and a method of making hollandaise sauce, specifically using a container made of a high temperature resin and a method using a container made of a high-temperature resin holding an ingredient, namely butter, heated at a high temperature to make hollandaise sauce.

### BACKGROUND

Hollandaise sauce is a sauce used in breakfast foods, such as eggs benedict and omelets. The basic ingredients to make hollandaise sauce are egg yolk, lemon juice, and pure melted butter. The butter is melted and has the cream removed to make it pure. Then, egg yolks are whisked with lemon juice, and the butter is added contemporaneously as the yolk and juice are being whisked. It usually is served immediately after it is made.

Unfortunately, many restaurants are phasing hollandaise sauce out of their menu and have discontinued serving eggs benedict all together because of the impracticality of making high quality hollandaise sauce in large quantities. Although it is easily made in small batches, making it in large batches can be found to be more difficult because by allowing it to cool or making excess to store will result in flavor degradation and hollandaise sauce is susceptible to quickly spoiling. Restaurants are thus either forced to keep a batch warm on the stove or continually take time to make it in small batches. Hollandaise sauce can be purchased in stores, however it generally lacks the same quality as freshly made sauce. What is needed is a method to make hollandaise sauce in large quantities that allows pasteurize the sauce to retain its flavor longer and to keep from spoiling for an extended time. What is further needed is a apparatus or a container that would be useful in the making of the hollandaise sauce, allowing for the butter to be more easily mixed into the whisked egg yolk and lemon juice.

### BRIEF DESCRIPTION OF DRAWINGS

FIG. 1 is a perspective view of an embodiment of a container.

FIG. 2 is a perspective view of an embodiment of a container lid.

FIG. 3 is a side view of the embodiment of the container depicted in FIG. 1 attached to the embodiment of the container lid depicted in FIG. 2.

FIG. 4 is a rear perspective view of the container and container lid depicted in FIG. 3.

FIG. 5 is a front view of an embodiment of a container.

FIG. 6 is a side view of the embodiment of the container depicted in FIG. 5 with an embodiment of a container lid attached.

FIG. 7 is a top view of an embodiment of a container lid.

FIG. 8 is a front view of the container lid depicted in FIG. 7.

FIG. 9 is a side view of an embodiment a first container stacked in an embodiment of a second container.

### SUMMARY OF THE INVENTION

The purpose of the summary is to enable the public, and especially the scientists, engineers, and practitioners in the art who are not familiar with patent or legal terms or phraseology, to determine quickly from a cursory inspection, the nature and essence of the technical disclosure of the application. The summary is neither intended to define the inventive concept(s) of the application, which is measured by the claims, nor is it intended to be limiting as to the scope of the inventive concept(s) in any way.

What is disclosed is a container for use in food preparation having a container body. The container body defines a top opening. The container is made of high temperature resin configured for heating an edible liquid to a temperature of 315° to 345° Fahrenheit. The edible liquid is preferably butter but can also be food items such as margarine, cooking oil, or other similar liquids used in cooking. Preferably the container is in the shape of a pitcher and preferably is a single molded piece.

The container has a handle positioned on the exterior of said container body and a spout positioned adjacent to said top opening and configured for pouring said edible liquid from the container.

The container body preferably has a removable lid configured for at least partially covering the top opening and securing the lid to the container body. The removable lid is preferably configured to allow pouring of an edible liquid through the spout when the removable lid is secured to the container body. The removable lid preferably defines an opening configured for the insertion of a thermometer. The removable lid is preferably made from similar high temperature resin material as the container body.

The container body preferably has an upper ridge and a lower ridge that are positioned below the spout configured to allow to container to be rested via the ridges on a secondary container when said edible liquid is being poured from said container. The container preferably is configured to be stackable.

What is further disclosed is method for making hollandaise sauce. This method preferably has the steps of placing a quantity of butter into a container. The container has a container body made of high temperature resin configured for heating butter in a microwave to a temperature of 315° to 345° Fahrenheit. The container body preferably has a top opening, a handle positioned on the container body, and a spout positioned adjacent to the top opening.

The method has the step of placing the container with said butter in a microwave and heating the butter to 315° to 345°. At least a portion of the butter is then poured into a bowl with a desired plurality of eggs and a desired quantity of lemon juice. The combination of butter, eggs, and lemon juice is then mixed into hollandaise sauce.

The container used in the method preferably has a removable lid configured for at least partially covering said top opening and securing the lid to the container body. The removable lid is preferably configured to allow pouring of the butter when the removable lid is secured to the container body. The removable lid preferably defines an opening configured for the insertion of a thermometer. The removable lid is preferably configured to allow pouring of the butter when the removable lid is secured to the container body.

The container body preferably has an upper ridge and a lower ridge positioned below the spout configured to allow the container to be rested on via the ridges on a secondary container when butter is being poured from the container.

Still other features and advantages of the claimed invention will become readily apparent to those skilled in this art from the following detailed description describing preferred embodiments of the invention, simply by way of illustration of the best mode contemplated by carrying out my invention. As will be realized, the invention is capable of modification in various obvious respects all without departing from the invention. Accordingly, the description of the preferred embodiments is to be regarded as illustrative in nature, and not as restrictive in nature.

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined herein.

### DETAILED DESCRIPTION OF THE PREFERRED EMBODIMENTS

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined in the claims.

What is disclosed is a method to make a plurality of servings of hollandaise sauce. The method includes the step of heating butter to temperatures of 315°-345° Fahrenheit in a container made of a high temperature resin material that is configured to withstand such heat in a microwave. The heated butter is then poured from the container into a mixture of eggs and lemon juice while the mixture is being whisked. Pouring the heated butter with the egg and lemon juice mixture will create a plurality of servings of hollandaise sauce. In the inventor's opinion, the high temperature of the butter will pasteurize the sauce, allowing for the hollandaise sauce to retain its flavor for a prolonged amount of time and to keep from spoiling for even longer.

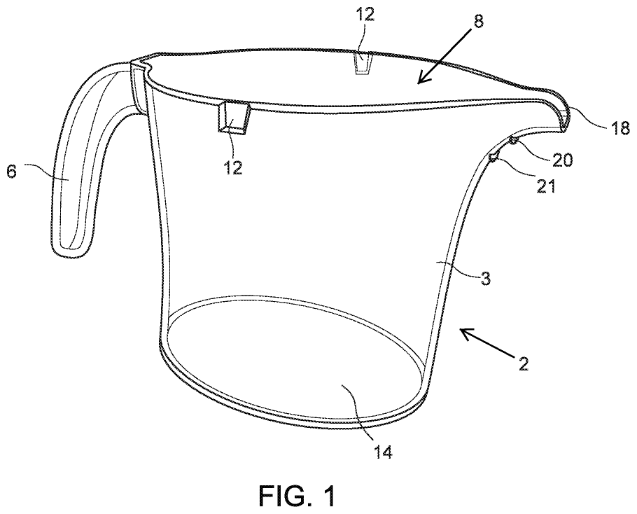

FIG. 1 illustrates a preferred embodiment of the container 2. In a preferred embodiment, the container 2 is composed of a resin that is capable of withstanding high temperatures above 300°, and preferably 345°. The resin preferably is a light-weight, strong material that will make it easy to carry. Suitable high-temperature resins include high-temperature resins known in the art. The container 2 can also be shaped to different dimensions to accommodate varying volumes.

In a preferred embodiment, the container 2 has a container body 3 with a generally flat base 14. The container body preferably has an opening 8 above. Preferably the container body 3 has latching arms 40 on each side of the container body 3. The container body 3 has a handle 6 preferably attached to the container body 3 at the rear of the container 2. In a preferred embodiment this handle 6 will be attached in a semicircular fashion as to maximize strength and support of the handle 6. In alternate embodiments the handle can be constructed of other means known in the art to support the weight of the container.

A spout 18 is preferably attached to the container body 3 opposite of the handle 6. In a preferred embodiment, the spout 18 will be a semi-circular spout projecting from the container 2, through which liquid can flow through the spout opening 18. In alternate embodiments, the spout can also be a tube or any other shape capable of directing the flow of liquid.

In a preferred embodiment, a first ridge 20 and a second ridge 21 are integrally attached to the container body 3. The first ridge 20 and second ridge 21 are configured to prevent the container 2 from slipping when the contents of container 2 are being poured into a receiving apparatus such as a separate container, a bowl, a pot, or other similar apparatus. The space between the first ridge 20 and second ridge 21 can vary depending on the size of the desired receiving apparatus.

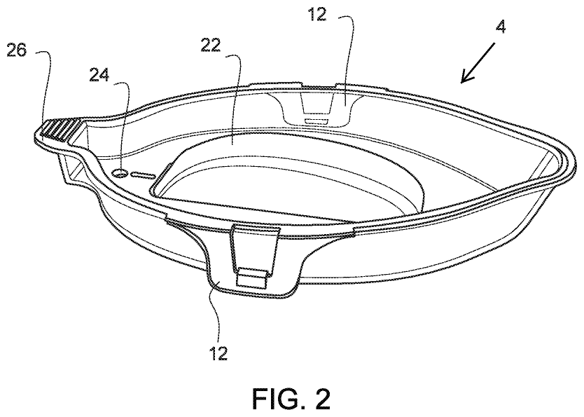

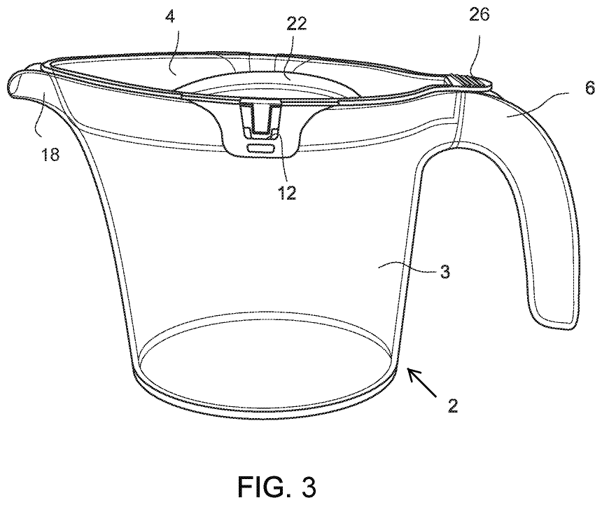

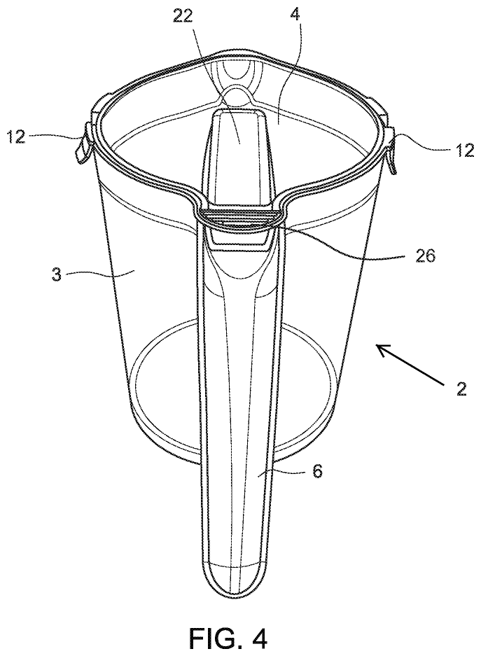

FIG. 2 illustrates a preferred embodiment of a container lid 4. The container lid 4 is preferably configured to cover the opening 8 by being partially inserted into the container body 3 to provide a force fit against the walls of the container body 3. A pair of latches 12 are configured to secure the container lid 4 to the container (illustrated in FIGS. 3 and 4). The container lid 4 preferably has a lid opening 24 that is configured to receive a thermometer. The container lid 4 preferably has a handle 22 configured for a user to grasp to remove the container lid 4 from the container or to carry the container lid 4. The container lid 4 preferably has a lip 26 that extends over the handle (illustrated in FIGS. 3 and 4) that is configured for a user to remove the container lid 4 from the container.

FIGS. 3 and 4 illustrate a preferred embodiment of the container 2 with a preferred embodiment of a container lid 4 secured to the container 2. The pair of latches 12 attach to the latching arms 40 to secure the container lid 4 to the container 2. A lip 26 is configured to extend over the handle 6 so that a user can easily remove the container lid 4 when the latches 12 are released from the latching arms 40. The container lid 4 is configured for a secure fit against the container body 3 to minimize the amount of heat loss and prevent the contents of the container 2 from spilling or leaking.

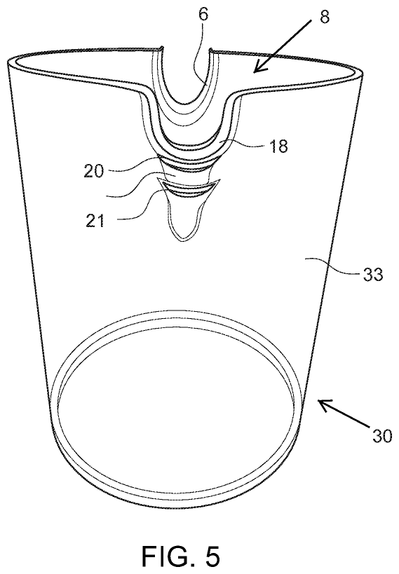

FIG. 5 depicts an embodiment of the container 30. In a preferred embodiment, the spout 18 opens to the inside of the container 30 and is configured to allow the container 30 to pour when tilted by the handle 6. The ridges 20, 21 are positioned on the container body 3 below the spout and configured so that the when the container 30 is being poured into a receiving container the container 30 does not slip from the edges of the receiving container.

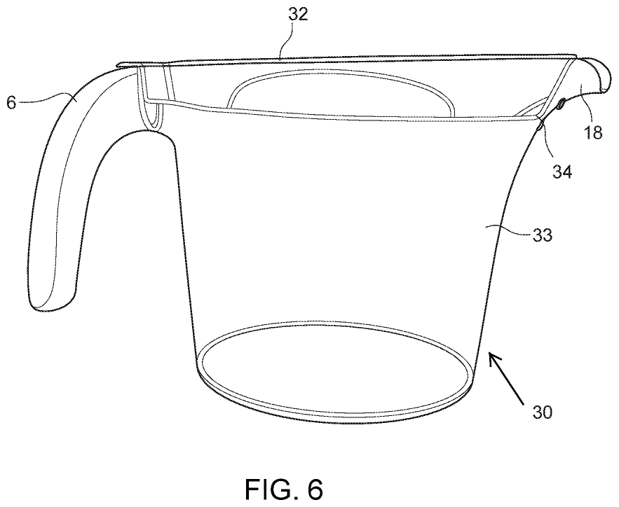

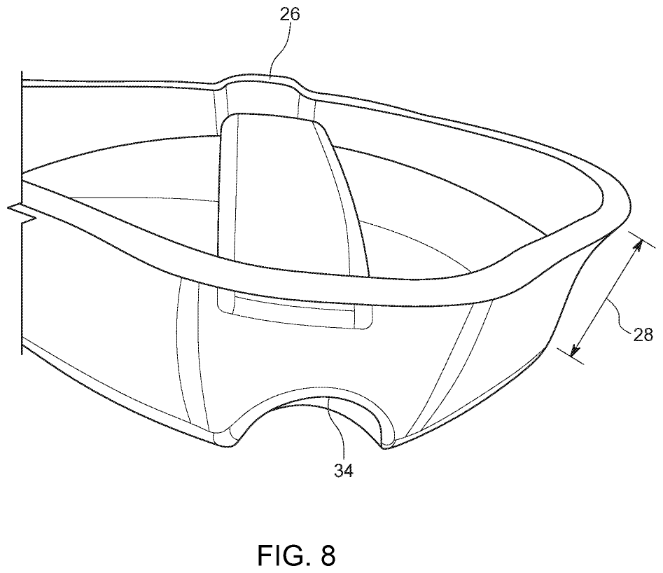

FIG. 6 depicts an embodiment of the container 30. A container lid 32 is configured to cover the opening of the container 30 and provides a depth (illustrated in FIG. 8) configured to be partially inserted into the container body 33 to provide a force fit against the walls of the container body 33.

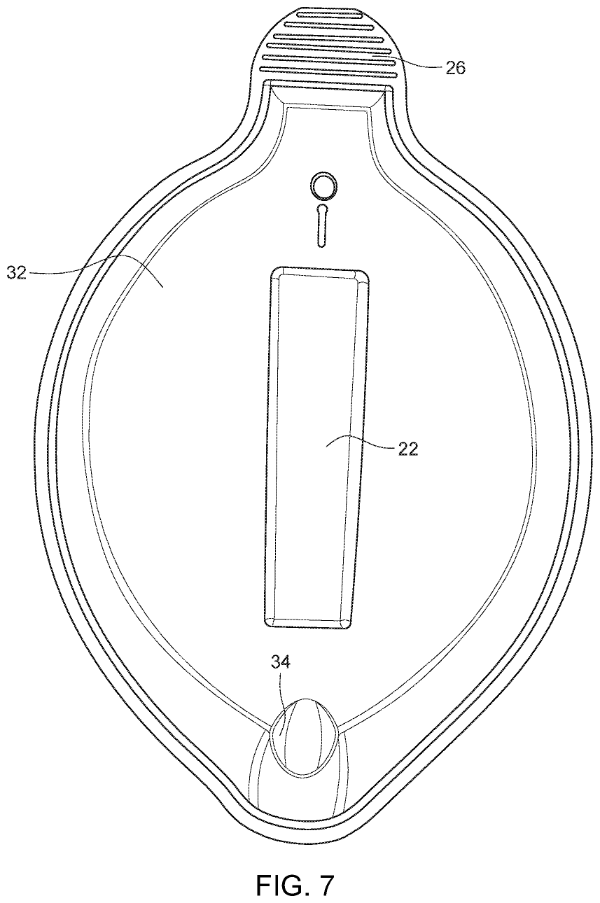

FIGS. 7 and 8 depict an embodiment of the container lid 32. In a preferred embodiment, the container lid 32 has a semicircular opening 34 that corresponds to the opening of the spout 18. The semi-circular opening 34 can also have a filter to filter out impurities in the substance when pouring. The semicircular opening 34 and spout 18 preferably combine for a circular opening that allows for directed pouring when the container lid 32 is attached to the container. The container lid 32 is configured to provide a depth 28 that is configured to be partially inserted into a container body to provide a force fit.

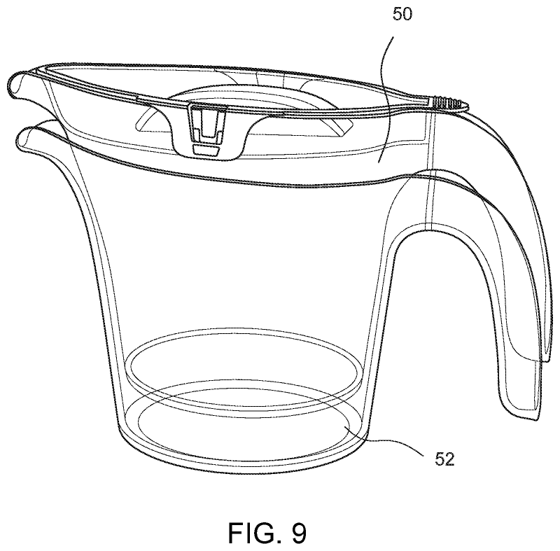

FIG. 9 illustrates two containers 50, 52. The walls of the container can be constructed to allow the container 50 to stack within a second container 52.

Still other features and advantages of the presently disclosed and claimed inventive concept(s) will become readily apparent to those skilled in this art from the following detailed description describing preferred embodiments of the inventive concept(s), simply by way of illustration of the best mode contemplated by carrying out the inventive concept(s). As will be realized, the inventive concept(s) is capable of modification in various obvious respects all without departing from the inventive concept(s). Accordingly, the drawings and description of the preferred embodiments are to be regarded as illustrative in nature, and not as restrictive in nature.

While certain exemplary embodiments are shown in the Figures and described in this disclosure, it is to be distinctly understood that the presently disclosed inventive concept(s) is not limited thereto but may be variously embodied to practice within the scope of this disclosure. From the foregoing description, it will be apparent that various changes may be made without departing from the spirit and scope of the disclosure as defined herein.

I claim:

1. A container for use in food preparation comprising:
a container body, wherein said container body defines a top opening, said container body comprising high temperature resin, wherein said high temperature resin is configured for heating an edible liquid to a temperature of 315° to 345° Fahrenheit;
a handle positioned on the exterior of said container body; and
a spout positioned adjacent to said top opening and configured for pouring said edible liquid from said container.

2. The container of claim 1, wherein said container body further comprises a removable lid, said removable lid is configured for at least partially covering said top opening and securing to said container body.

3. The container of claim 2 wherein said removable lid is configured to allow pouring of said edible liquid through said spout when said removable lid is secured to said container body.

4. The container of claim 2, wherein said removable lid defines an opening, wherein said opening is configured for the insertion of a thermometer.

5. The container of claim 1, wherein an upper ridge and a lower ridge are positioned below said spout, wherein said upper ridge and said lower ridge are configured to allow said container to be rested via said ridges on a secondary container when said edible liquid is being poured from said container.

6. The container of claim 1 wherein said container is configured to be stackable.

7. A container for use in food preparation comprising:
a container body, wherein said container body defines a top opening, said container body comprising high temperature resin, wherein said high temperature resin is configured for heating an edible liquid in a microwave to a temperature of 315° to 345° Fahrenheit;
wherein said container body further comprises a removable lid, said removable lid is configured for covering said top opening and securing to said container body, wherein said removable lid is configured to allow pouring of said edible liquid when said removable lid is secured to said container body;
a handle positioned on the exterior of said container body;
a spout positioned adjacent to said top opening and configured for pouring said edible liquid from said container.

8. The container of claim 7 wherein said container is configured to be stackable.

9. The container of claim 7, wherein said removable lid defines an opening, wherein said opening is configured for the insertion of an attachable thermometer.

10. The container of claim 7, wherein said container body further comprises an upper ridge and a lower ridge positioned below said spout, wherein said upper ridge and said lower ridge are configured for preventing slipping of said container when contents of said container are being poured.

11. A method for making hollandaise sauce comprising the following steps:
the step of placing a quantity of butter into a container, said container comprising:
a container body, said container body comprising high temperature resin configured for heating butter in a microwave to a temperature of 315° to 345° Fahrenheit;
wherein said container body defines a top opening;
a handle attached to said container body; and
a spout attached to said container body and positioned adjacent to said top opening;
the step of placing said container with said butter in a microwave and heating said edible liquid to 315° to 345°;
the step of providing and combining a plurality of eggs and a quantity of lemon juice in a bowl;
the step of mixing said plurality of eggs and said quantity of lemon juice into a mixture;
the step of pouring at least a portion of said quantity of butter heated to 315-345° Fahrenheit into said mixture;
the step of mixing said quantity of butter and said mixture into a sauce.

12. The method of claim 11 wherein said container body further comprises a removable lid, said removable lid is configured for at least partially covering said top opening and securing to said container body, wherein said removable lid is configured to allow pouring of said edible liquid when said removable lid is secured to said container body.

13. The method of claim 12 wherein said removable lid defines an opening, wherein said opening is configured for the insertion of a thermometer.

14. The method of claim 12 wherein said removable lid is configured to allow pouring of said edible liquid when said removable lid is secured to said container body.

15. The method of claim 11 wherein said container body further comprises an upper ridge and a lower ridge positioned below said spout, wherein said upper ridge and said lower ridge are configured to allow said container to be rested via said ridges on a secondary container when said edible liquid is being poured from said container.
